(19) United States
(12) Patent Application Publication
(10) Pub. No.: US 2002/0075551 A1
(43) Pub. Date: Jun. 20, 2002

(54) Enclosure for MEMS apparatus and method of using the same

(75) Inventors: Michael J. Daneman, Pacifica, CA (US); Behrang Behin, Berkeley, CA (US); Franklin Wall, Vacaville, CA (US)

Correspondence Address: JOSHUA D. ISENBERG, 204 CASTRO LANE, FREMONT, CA, 94539, US

(73) Assignee: Onix Microsystems, Inc, Richmond, CA

(21) Appl. No.: 09/989,905

(22) Filed: Nov. 20, 2001

Related U.S. Application Data
(60) Provisional application No. 60/250,237, filed on Nov. 29, 2000.

(51) Int. Cl. G02F 1/00

(52) U.S. Cl. 359/254

(57) ABSTRACT

An enclosure for sealing a MEMS optical device, a MEMS apparatus, a MEMS module, and a method for switching optical signals are disclosed. The enclosure includes one or more sidewalls and an optical element hermetically sealed to at least one of the sidewalls. Suitable optical elements include windows, lenses and lens arrays. The enclosure may be evacuated to improve the performance of the MEMS device enclosed within it. The MEMS apparatus includes a MEMS device enclosed by an enclosure of the type described above. The MEMS device may include a substrate and the enclosure may be bonded to the substrate. Alternatively, the MEMS device may include a substrate attached to a mount and the enclosure may be bonded to the mount. The MEMS module includes a mount and a MEMS device attached to the mount. One or more optical fibers are attached to the mount proximate the MEMS device. An enclosure, attached to the mount encloses the MEMS device. The fibers are located outside the enclosure. Optical signals may be coupled between the fibers and the MEMS device within the enclosure through an optical elements in the sidewall. The optical switching method proceeds by reducing a pressure of an atmosphere proximate the MEMS optical device and moving at least one of the optical elements from a first position to a second position. The optical element deflects an optical signal when it is in the second position.

This application claims priority from Provisional Application No. 60/250,237, filed Nov. 29, 2000, the entire disclosures of which are incorporated herein by reference.

### FIELD OF THE INVENTION

This invention relates generally to microelectromechancial systems (MEMS) devices. More particularly, it relates to a structure for protecting MEMS devices.

### BACKGROUND OF THE INVENTION

Advances in thin film technology have been leveraged to create devices using microelectromechanical systems (MEMS) elements. MEMS elements are typically capable of motion or application of a force. Devices using MEMS elements have been developed for a wide variety of applications due to their low cost, high reliability and extremely small size. MEMS elements have been utilized as microsensors, microgears, micromotors and other microengineered components. Microelectromechanical systems (MEMS) have become an increasingly critical part of optical and fiber-optic applications, including optical switching, multiplexing, scanning, and adaptive optics. One important optical application of such MEMS devices has been in free-space optical switches for fiber optic communications systems. MEMS optical elements, e.g., in the form of rotatable MEMS mirrors, are arranged in square or rectangular arrays called a switch fabric. The switch fabric is aligned with two or more corresponding arrays of optical fibers. The mirrors move into position in which they can selectively couple light from a fiber in one array to a fiber in another array.

MEMS free-space optical switches can be categorized into two major approaches: the planar matrix (2-dimensional) approach, and the beam-steering (3-dimensional) approach. The 2D approach typically utilizes mirrors that move between an “ON” position and an “OFF” position. The known 2D MEMS optical switch designs implement moving mirrors arranged in a cross-bar array for reflecting light from an input fiber to an output fiber. These 2D MEMS optical switches exhibit low crosstalk and low insertion loss. In one type of prior art 2D free-space optical switch; MEMS mirrors are attached to a substrate by flexures. The mirrors rotate under the influence of a magnetic force from an “OFF” position substantially parallel to the substrate to an “ON” position substantially perpendicular to the substrate. In the “ON” position, the mirror intercepts an optical beam from a fiber in an input array and deflects the beam toward a fiber in an output array. A top chip attached to the substrate has openings that align with the MEMS mirrors. The openings in the top chip provide reference stopping planes for the MEMS mirrors so that they are properly aligned perpendicular to the substrate in the “ON” position. A voltage applied between a particular mirror and the top chip provides an electrostatic force that retains the mirror in the “ON” position.

MEMS devices are often fragile and can require specialized atmospheres to operate. Often, the MEMS actuator, supporting electronic components, and elements/energy that interact with the MEMS device create heat that can adversely impact the MEMS device operation if the heat is not shielded or removed, respectively, from the MEMS device itself. Moisture in the atmosphere can also adversely impact MEMS device operation by causing corrosion which can damage a MEMS device. In addition, MEMS devices having moving parts may operate at different speeds in different atmospheric pressure due to different damping forces that may impede the movement of the MEMS device. Moving parts can require operation in a substantially dust-free environment, as dust particles may interfere with operation of the MEMS device. As so, for this reason handling and aligning optics to exposed MEMS device in a manufacturing environment can be a difficult and low yielding process. It is, therefore, desirable to seal the MEMS devices shortly after fabrication, before further handling and/or alignment takes place and to achieve benefits of thermal management, moisture protection, reliability, lifespan and performance.

Hermetic packaging of fiber-optic components is a critical requirement in many telecommunications applications. This is especially true for active components such as lasers and detectors, and environmentally sensitive components such as MEMS structures. Typically, optical fibers must be aligned and interfaced with these components. Optical fibers can be hermetically sealed to an enclosure. However hermetically sealing around optical fibers often requires metallization of the fibers, which can be an expensive and low-yielding process.

A critical performance parameter of 2D MEMS free-space optical switches is the switching time. The switching time may be regarded as the time it takes for a given MEMS mirror to switch from an “OFF” state to an “ON” state or vice versa. For high performance switches, it is desirable to make the switching time as short as possible. Certain of the obstacles to improved switching times arise from the design of the MEMS mirrors themselves. For example, when a MEMS mirror is in the “OFF” position, it often rests against an underlying base or substrate. Attractive forces may be exerted between mirror and the base. These attractive forces, known as “stiction” inhibit the free rotation of the mirror. Stiction can increase switching times. Stiction may be overcome by increasing the strength of the magnetic field, but this increases the overall power consumption of the switch. Alternatively stiction may be overcome by designing the MEMS mirror with landing pads that reduce the overall contact area. However this may increase the overall cost of the MEMS device. Furthermore it is difficult, if not impossible, to retrofit MEMS devices with such landing pads. In addition to stiction, a drag force, referred to as “squeeze film damping,” may increase the switching time of the MEMS mirror. This type of drag is the result of fluid such as air trapped between the MEMS mirror and the underlying substrate. Increased switching times due to stiction, squeeze film damping or viscous damping lead to slower switching speeds and poor switch performance.

Thus, there is a need in the art, for a MEMS apparatus and method that overcomes these disadvantages.

### SUMMARY OF THE INVENTION

The disadvantages associated with the prior art are overcome by the invention of an enclosure for sealing a MEMS optical device, a MEMS apparatus, a MEMS module, and a method for switching optical signals.

The enclosure includes one or more sidewalls and an optical element sealed or coupled to at least one of the sidewalls. The optical element may be formed from or coupled to at least one of the sidewalls. Optical signals may travel through the sidewall via the optical element. Suitable optical elements include windows, simple refractive surfaces, partially reflective surfaces, curved refracting or partially reflecting, surfaces, prisms, lenses, diffractive elements, fresnel lenses, and dichroic coated surfaces. The optical elements may be made of silicon, glass, sapphire, or other materials including those deemed suitable for optical transmission and/or hermitic sealing. The enclosure may include a topside layer disposed on top of the enclosure. The topside layer material, optical element and window can be specified to perform one or more desired functions such as to reflect heat generated outside the device to thermally isolate the MEMS device; transmit heat generated inside the MEMS device to an external heat sink; transmit atmosphere into the MEMS device; isolate particles from entering into the MEMS device; provide optical access via a window into the MEMS device, and; filter, focus, disperse, isolate and/or pass energy entering or exiting the MEMS device.

The enclosure may also be fully or partially evacuated to improve the performance of the MEMS device enclosed within it. It may optionally be injected with a gas to alter the atmosphere of the MEMS device and enable an operation than could not be performed in ambient atmosphere. The gas may be electrically or thermally conductive, insulator, optically opaque or transparent, depending on configuration and application.

The MEMS apparatus includes a MEMS device enclosed by an enclosure of the type generally described above. The MEMS device may include a substrate and the enclosure may be bonded to the substrate, formed therefrom, deposited thereon or some combination thereof. Alternatively, the MEMS device may include a substrate attached to a mount and the enclosure may be bonded to the mount. In one specific example, optical signals may be coupled between a MEMS optical switching device and one or more externally mounted fibers via the optical element in the sidewall of the enclosure. A device controller chip may be coupled to the substrate and the enclosure evacuated to improve performance are reliability of the optical switch.

In the continuing optical switch example, A MEMS module may include a mount and a MEMS device attached to the mount. One or more optical fibers are attached to the mount proximate the MEMS device. An enclosure, attached to the mount encloses the MEMS device. The fibers may be located outside the enclosure. The enclosure may have one or more vertical or angled sidewalls with or without relief's and at least one sidewall may include one or more optical elements. The optical elements may be hermetically sealed, anodically bonded, soldered, glued to an opening in the sidewall. The enclosure with optical elements may be monolithically fabricated in one piece using anisotropic etching of single crystal silicon. The enclosure may also be formed of silicon using traditional machining, where the enclosure is machined from silicon and slots are cut into the sidewalls, and silicon optical elements are attached using a solder, anodically bonding, glue, etc Optical signals may be coupled between the fibers and the MEMS device within the enclosure through the optical elements in the sidewall.

The optical switching method of the present invention uses a MEMS optical device having one or more moveable MEMS optical elements. The method proceeds by reducing a pressure of an atmosphere proximate the MEMS optical device and moving at least one of the optical elements from a first position to a second position. The optical element deflects an optical signal when it is in the second position. The MEMS optical device may be sealed within an enclosure after the pressure has been reduced. The MEMS optical element may be returned to the first position after deflecting the optical signal. Embodiments of the present invention provide for protection of sealed MEMS devices while allowing for their improved reliability and performance.

### BRIEF DESCRIPTION OF THE DRAWINGS

The teachings of the present invention can be readily understood by considering the following detailed description in conjunction with the accompanying drawings, in which:

FIG. 1 depicts a simplified side cross-sectional schematic diagram of an enclosed MEMS apparatus according to an embodiment of the invention;

FIG. 2 depicts a simplified side cross-sectional schematic diagram of an enclosed MEMS apparatus according to an alternative embodiment of the invention;

FIG. 3 depicts a side cross section of an enclosure in the form of a cap assembly with an optical element attached to the side-wall of the cap according to an embodiment of the present invention;

FIG. 4 depicts a side cross section of a portion of an enclosure having sidewall assembly with a window, attached to a recessed, angled surface according to an embodiment of the present invention;

FIG. 5 depicts a side cross section of a portion of an enclosure having sidewall assembly with a window, attached to a recessed, angled surface according to an embodiment of the present invention;

FIG. 6 depicts a simplified block diagram of a MEMS module according to an alternative embodiment of the invention;

FIG. 7 depicts a simplified side cross-sectional schematic diagram of an enclosed MEMS device according to an alternative embodiment of the invention;

FIG. 8 depicts a graph of pressure versus switching time for a MEMS device; and

FIG. 9 depicts a flow diagram of a high speed optical switching method according to an embodiment of the invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention or to the plurality of fields in which it may be applied. Like numbers refer to like elements throughout. References to same elements are indexed by an offset multiple of 100 in each succeeding figure.

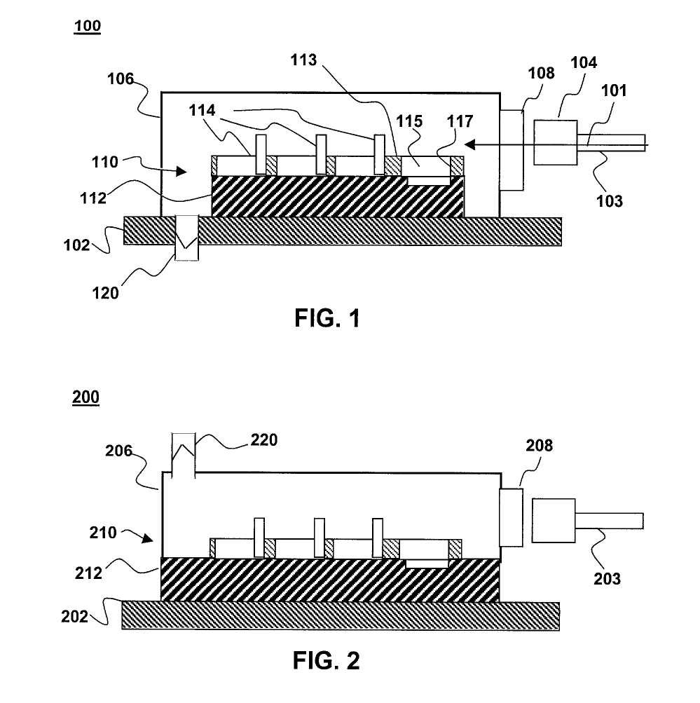

This invention proposes an apparatus for protecting MEMS devices with a cap assembly having optical windows perpendicular (or nearly perpendicular) to the plane of the MEMS substrate. The invention also proposes a MEMS device having such an enclosure. In one application, the MEMS device may be an optical switch having one or more MEMS elements, such as movable mirrors that rotate or translate to deflect light from one or more optical fibers. The dimensions of the enclosure may relate to the dimensions of the MEMS device such that the device itself is enclosed, but fibers or lenses, sensors or other devices that are optically or otherwise coupled to the device may remain outside the enclosure. As shown in FIGS. 1, the MEMS package 100 generally includes a mount 102, which may be ceramic, FR4, or otherwise, to which a MEMS device 110 is attached, e.g., by die bonding, and an enclosure 106 having one or more optical elements such as a window 108. In this example, optical signals 101 may be coupled to the MEMS device 110 from an optical fiber 103 via the window 108 and a collimator 104, such as a graded refractive index (GRIN) lens. The window 108 may be angled to restrict undesired coupling of reflected light back into the fibers or the MEMS device itself.

The enclosure 106 may be bonded to the mount 102 in such a way as to provide a hermetically sealed environment within the enclosure 106. The enclosure 106 may be a cap assembly consisting of a ring-frame with at least one cut-out for window, a top-cap hermetically attach to a ring-frame, and optical windows that are hermetically attached to the ring-frame. In another option, the enclosure 106 may be fabricated as a single piece. The window 108 may be attached to the enclosure 106 using solder, glass-frit, glass-to-metal seal, or another method. In another option the enclosure 102 may include an entire ring-frame fabricated of an optically transparent material where the window 108 would be inherent in the ring-frame. The enclosure 106 may be evacuated, e.g., through a sealable passage 120 in the mount 102, to provide improved switching performance as described below. As used herein, the term evacuated describes a situation in which the atmospheric pressure has been reduced below an ambient atmospheric pressure. By way of example, and without loss of generality, the ambient pressure of the earth's atmosphere is approximately 760 Torr at mean sea level.

With respect to the example shown, MEMS device 110 generally includes a substrate 112, and an array of MEMS optical elements 114 moveably attached to the substrate. Each of the MEMS device 110 may include an NXN or NXM array of MEMS optical elements 114, where N and M are integers. By way of example, each MEMS optical element 114 may be in the form of a flap attached to the substrate 112 by one or more flexures (not shown). The MEMS optical elements 114 may include light-deflecting elements such as simple plane reflecting (or partially reflecting) surfaces, curved reflecting (or partially reflecting) surfaces, prismatic reflectors, refractive elements, prisms, lenses, diffractive elements, e.g. fresnel lenses, dichroic coated surfaces for wavelength specific and bandpass selectivity, or some combination of these. In a particular embodiment, the optical elements 114 may include reflective surfaces so that may act as MEMS mirrors. The MEMS optical elements 114 may move between an “OFF” position and an “ON” position under the influence of an actuating force, such as a magnetic force, electrostatic force, force generated by a thermal bimorph, etc. By way of example the MEMS optical elements 114 may be oriented substantially parallel to the substrate 112 in the “OFF” position and substantially perpendicular to the substrate 112 in the “ON” position. In the “ON” position, the MEMS optical elements 114 deflect the optical signals 101. The device 110 may further include clamping surfaces to orient and retain the MEMS optical elements 114 in the “ON” position. Such clamping surfaces may be provided by a “top chip” 113 having openings 115 that may receive the optical elements 114. The openings 115 may include sidewalls 117 that provide the clamping surfaces. The sidewalls 117 provide reference stopping-planes for the MEMS optical elements 114. Alternatively, the top-chip 113 may include clamping surfaces in the form of a single vertical wall or two vertical walls with a hole therebetween to allow light to pass. Such a vertical wall or walls may be higher than the MEMS optical elements 114. A voltage may be applied between individual optical elements 114 and the top chip 113 to electrostatically clamp the optical elements 114 in the “ON” position. The optical elements 114 may be electrically insulated from the sidewalls 117 by an insulating gap, such as an air gap.

In an alternative embodiment depicted in FIG. 2, an apparatus 200 may, include an enclosure 206 that is directly bonded to a substrate 212 of a MEMS device 210 having features in common with the MEMS device 110 of FIG. 1. The enclosure 206 may include an optical element such as a window 208. The window 208 may be angled to restrict undesired coupling of reflected light back into one or more optical fibers 203 or the MEMS device 210 itself. The enclosure 206 may be bonded to the substrate 212 in such a way as to provide a hermetically sealed environment within the enclosure 206. The enclosure 206 may be a cap assembly consisting of a ring-frame with cutouts for the window 208, a top-cap hermetically attached to a ring-frame, and optical windows that are hermetically attached to the ring-frame. In another option, the enclosure 206 may be fabricated as a single piece. The window 208 may be incorporated into enclosure 206 or attached to the enclosure 206 using solder, glass-frit, glass-to-metal seal, or another method. In another option the enclosure 202 may include an entire ring-frame fabricated of an partially, fully or selectively optically transparent material where the window 208 would be inherent in the ring-frame. The inside of the enclosure may be painted dark or coated with a material to absorb photons, for example, in an optical cross-connect application to reduce optical back reflection. The enclosure 206 may be evacuated e.g., through a sealable passage 220 in a top of the enclosure 206, to provide improved switching performance as described below.

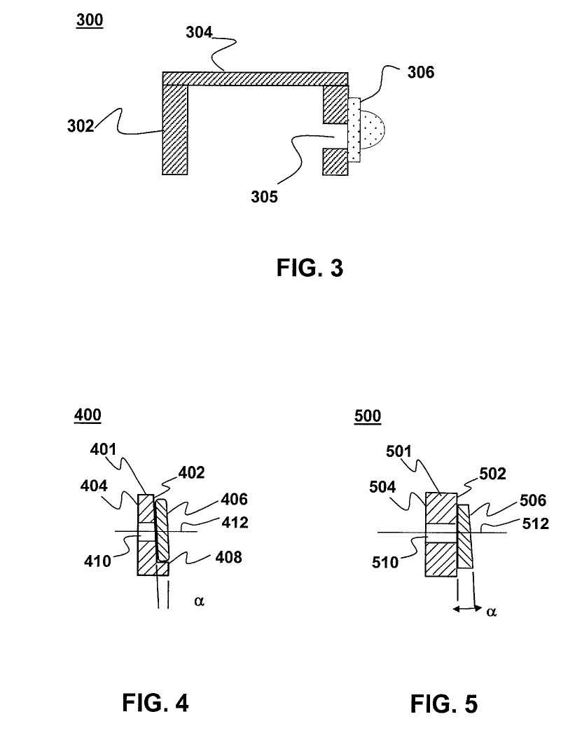

Although FIG. 1 and FIG. 2 include enclosures with windows as optical elements, other optical elements may be incorporated into the enclosures. For example, FIG. 3 depicts a side cross-section of an enclosure in the form of a cap assembly 300 having a ring frame 302 a top cap 304 and one or more optical elements 306. The cap assembly 300 may be hermetically sealed to a mount as described above with respect to FIG. 1 and FIG. 2. The ring frame 302 has one or more cutouts 305 on one or more sidewalls that receive the optical elements 306. Optical signals may travel through the ring frame 302 via the optical elements 306 and the cutouts 305. The top-cap 304 may be hermetically attached to the top of the ring-frame 302.

The optical elements 306 may be made of glass, silicon, ceramic, or other optically transmissive materials. The optical elements 306 may be attached to the ring-frame 304 using solder, glass-frit, glass-to-metal seal, and other methods. The optical elements 306 may be windows, simple refractive surfaces, partially reflective surfaces, curved refracting (or partially reflecting) surfaces, prisms, lenses, diffractive elements, e.g. fresnel lenses, dichroic coated surfaces for wavelength specific and bandpass selectivity, or some combination of these. If the optical elements 306 are lenses, they may be fiber lens arrays, graded refractive index (GRIN) lenses, or one or more arrays micro-lenses. The optical elements 306 may be hermetically attached to the sidewalls of the ring-frame 302 at the cutouts 305.

It should be understood that the optical elements 306 may be configured in an optical cross-connect switch, such that the optical loss of the switch is equalized for different connections. One way to accomplish equalized beam spreading in all connections is to equalize the optical path lengths between input and output fibers. Path-equalizing refractive and reflective components such as a stairstep blocks or triangular prisms may be used for this purpose.

Although a separate ring frame and top-cap are depicted in FIG. 3, the ring-frame 302 and the top-cap 304 may alternatively be fabricated as a single piece. The cap assembly 300 may be attached to an underlying substrate so as to align the optical elements 306 to the components inside the cap within the required tolerance. The environment within the cap assembly 300 may be evacuated or partially evacuated to reduce the atmospheric pressure within the space enclosed between the cap assembly and the substrate. Optical fibers may be aligned to the optical elements 306 of the cap assembly 300 and secured in place.

As described above, optical elements, such as the windows 108, 208 may be tilted with respect to an optical axis to minimize back-reflection and interference effects. FIGS. 4 and 5 depict possible arrangements for the windows that may be used with the apparatus of FIGS. 1-3. In FIG. 4, a package sidewall assembly 400 includes a sidewall 401 having a front surface 402 and a back surface 404. A window 406 is attached to the front surface 402. The window 406 allows optical signals to pass, either selectively by wavelength or over a broad-band of 30 wavelengths. The window 406 can be made from a multitude of glass or ceramic types, Quartz, Sapphire, silicon, and other optically transmissive materials, with or without an anti-reflective coating. The window 406 may be attached by soldering, bonding, epoxy, glass frit, and the like.

The window 406 may be partly aligned and supported by an optional ledge 408 projecting from the front surface 402. The sidewall 401 includes an opening 410 that is aligned with an optical plane 412 for optical signals that travel through the window 406. The window 406 may be angled with respect to the optical plane or axis 412 along which optical signals travel to reduce undesired back-reflection effects of signals. One of the surfaces 402, 404 of the sidewall 401 may be angled to angle the window 406. The angled surface can be either the innermost or outermost surface of the sidewall 401. Furthermore, the angled surface can be recessed, to provide support and alignment for the window 406. The sidewall 401 does not necessarily have to be part of a package assembly. The window 406 can be pre-attached to a frame if preferred, with the frame being attached to the angled sidewall. The ends, sides, or surface of the windows can be used for attachment to the sidewall or frame. If preferred, the angled sidewall could be manufactured from glass or other optically transmissive materials, becoming the window.

In the embodiment shown in FIG. 4, the front surface 402 may be tilted with respect to the back surface 404 by an angle α, e.g., about 3°. The front surface 402 of the sidewall 401, may be angled, either by machining, molding, or forming, at an angle suitable to minimize the back reflection of coherent light through the attached window 406, while providing the ledge 408 as an acceptable surface for window attachment. The window 406 may be a flat window attached to the angled front surface 402. In the example shown in FIG. 4 the front surface 402 is the outside wall of the package assembly 400. The sidewall 401 may be a ring-frame, drawn tub, cap, or other package configuration of an enclosure such as those described above with respect to FIG. 1 and FIG. 2. The window 406 may alternatively be attached to an inside wall, recessed or not, hermetically sealed or not, forming an integral enclosure as described above with respect to FIG. 1 and FIG. 2.

Alternatively, as shown in FIG. 5, a package assembly 500 may include wedged window 506 may be attached to a sidewall 501 having substantially parallel front and back surfaces 502, 504 to provide the desired angle α. The wedged window 506 reduces the back reflection of coherent light through the attached window 506. Of course, some combination of angled sidewall and wedged window is also possible.

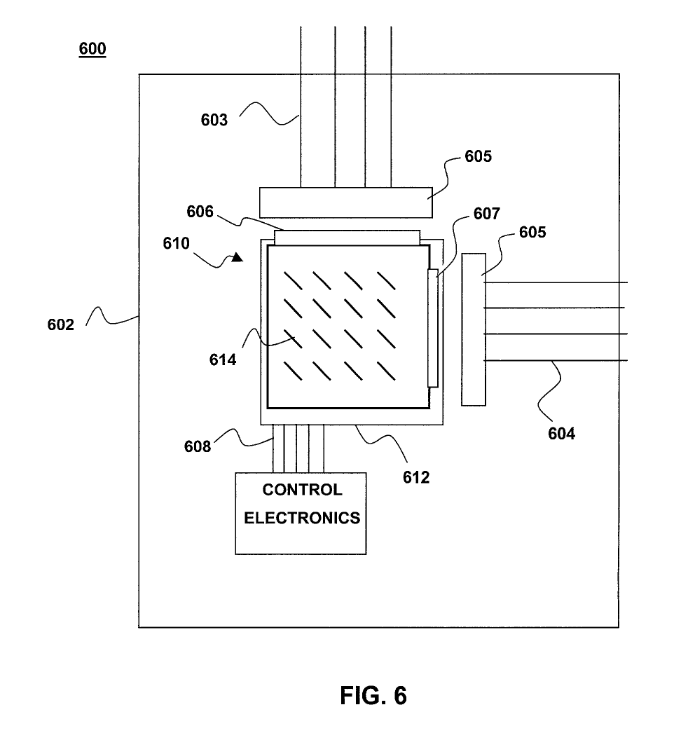

Enclosed MEMS devices of the types shown in FIG. 1 and FIG. 2 with package assemblies of the types shown in FIGS. 3-5 may be incorporated into an inventive MEMS module 600 as shown in FIG. 6. The module 600 generally includes a mount 602. The mount 602 is essentially a board or base to which the elements of the module 600 are attached. The mount 602 may be made of ceramic, FR4, or another material. A MEMS device 610, such as an optical switch, and control electronics 620 may be attached to the mount. The MEMS device 610 includes an enclosure 612 having vertical sidewalls with optical elements 606, 607 such as windows or lens arrays as described above. In the exemplary embodiment shown, the MEMS device 610 is an optical switch having an array of moveable mirrors 614. The switch may be used to selectively couple optical signals between one or more input fibers 603 and one or more output fibers 604. The fibers 603, 604 may be attached to the mount by conventional fiber mounts 605, 609 such as V-groove arrays and the like. The control electronics 620 may be electrically coupled to the MEMS device 610, e.g. by one or more control lines 608.

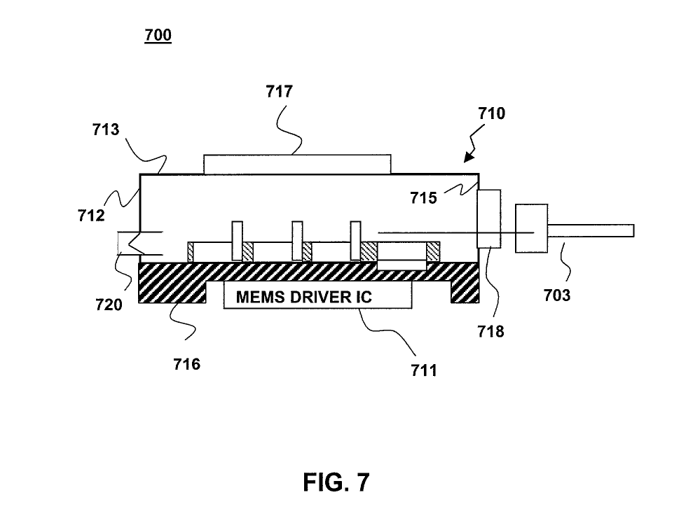

An alternative MEMS module 700, which is a variation on the module 600, is depicted in FIG. 7. In this embodiment, a MEMS device 710 is enclosed by an enclosure 712 as described above. The MEMS device 710 includes a device driver chip 711 mounted to a backside of a MEMS substrate 716. The driver chip 714 controls the MEMS device 710, e.g. via control lines 708 or other connectors that pass through the substrate 716. Such a device provides a completely sealed interchangeable module for use with larger MEMS modules. The enclosure 712 may optionally include an optical element, e.g., in the form of a transparent window 717 that is parallel to the plane of the substrate 716 of the MEMS device 710, e.g. on a top side 713 of the enclosure to facilitate inspection of the device. The enclosure 712 may also include a second optical element 718 that is attached to a sidewall 715. By way of example, the second optical element may be a window, lens or lens array as described above. The second optical element may facilitate transmission of optical signals 701 between an externally mounted optical fiber 703 and the MEMS device 710. The enclosure 712 may be evacuated, e.g., through a sealable passage 720 in the sidewall 715, to improve switching performance as described below.

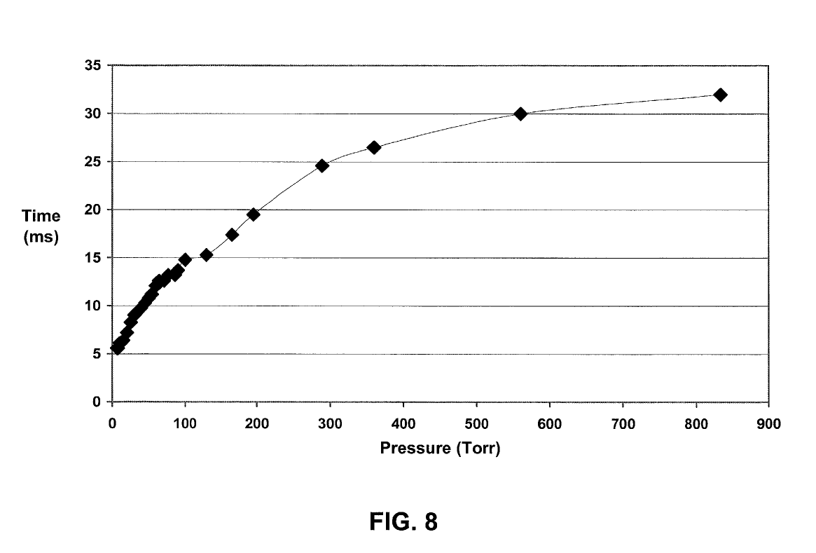

As described above, embodiments of the invention may include an evacuated enclosure that is hermetically sealed. The inventors have discovered that the switching time of a MEMS device may be greatly reduced by evacuating, or partially evacuating the environment surrounding the device. FIG. 8 depicts a graph of the rising time versus pressure for a MEMS device having features in common with those described herein. As used herein, the rising time is the time that it takes a MEMS optical element to move from an “OFF” position to an “ON” position. The particular device used was a magnetically actuated MEMS optical switch. It is desirable to reduce this time as much as possible in high speed switching applications. FIG. 8 shows that as the atmospheric pressure decreases in the environment containing the device, the switching time also decreases. For example, as the pressure decreased from about 800 Torr to about 100 Torr, the switching time decreased from about 30 ms to about 15 ms, a 50% reduction. Further reduction in pressure below about 100 Torr reduced the switching time to a little more than 5 ms.

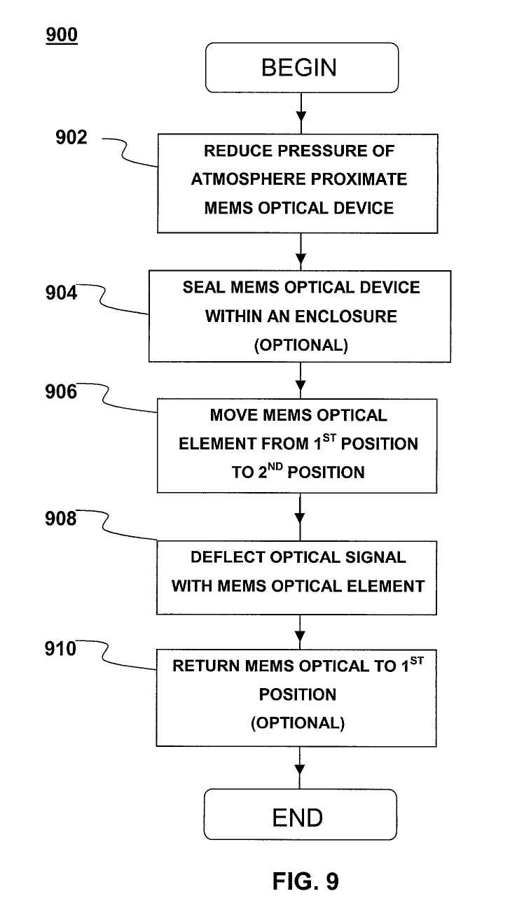

Encouraged by experimental data like that shown in FIG. 8 the inventors have developed a method for high speed optical switching. FIG. 9 depicts a flow diagram illustrating the steps of the method 900. At step 902, the atmospheric pressure proximate a MEMS optical device is reduced to some desired level. The MEMS optical device may be one of the types described above. In particular, the MEMS optical device may be an optical switch having one or more moveable MEMS optical elements of any of the types described above with respect to FIG. 1. The amount of pressure reduction depends on the desired switching time as can be seen from FIG. 8. There are several possible methods of reducing the atmospheric pressure. For example, an enclosure may be attached to the device as described above and coupled to an evacuating device, such as a vacuum pump. The pump may remove air or other gas from within the enclosure through a passage that may later be sealed after the enclosure has been sufficiently evacuated. Alternatively, the enclosure may be hermetically attached to the device in an evacuated environment. Furthermore, the device may operate in an evacuated environment. At optional step 904, the MEMS optical device may be hermetically sealed within the enclosure as described above. At step 906 the MEMS optical element moves from a first position to a second position. As can be seen from FIG. 8 this may be accomplished very quickly depending upon how much the pressure has been reduced. At step 908, while in the second position, the MEMS optical element deflects an optical signal from a first optical path to a second optical path. The MEMS optical element may return to the first position at optional step 910.

It will be clear to one skilled in the art that the above embodiments may be altered in many ways without departing from the scope of the invention. For example, the enclosure in any of the above embodiments may include a window that is substantially parallel to the MEMS substrate. Furthermore, the enclosure may be a dome, pillbox or other circular shape. It should be understood that the present invention may be used in a plurality of applications, including optical telecommunications, biotechnology—including but not limited to biological and chemical agent sensors, RF applications, gyroscopes, data processing, and; data storage and retrieval applications.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

What is claimed is:

1. An enclosure for sealing a MEMS device, comprising
one or more sidewalls,
an optical element coupled to at least one of the sidewalls,
wherein at least one of the one or more sidewalls or the optical element includes a surface that is angled with respect to an optical plane,
wherein the dimensions of the enclosure are such that the enclosure completely encloses the MEMS device.

2. The enclosure of claim 1, wherein the optical element is chosen from the group consisting of simple refractive surfaces, partially reflective surfaces, curved refracting or partially reflecting, surfaces, prisms, lenses, diffractive elements, fresnel lenses, anti-reflective coated surfaces, and dichroic coated surfaces.

3. The enclosure of claim 1, and the optical element is a window.

4. The enclosure of claim 1 further comprising an optically transparent window disposed on top of the enclosure.

5. The enclosure of claim 1, wherein the optical element is a wedge-shaped window.

6. The enclosure of claim 1, wherein the enclosure is evacuated.

7. The enclosure of claim 1, wherein the enclosure is filled with a gas.

8. The enclosure of claim 7, wherein the gas provides moisture-free environment for the MEMS device to operate in.

9. The enclosure of claim 7, wherein the gas is selected from the group consisting of thermal conductor, thermal insulator, electrical conductor and electrical insulator.

10. The enclosure of claim 7 where in the gas prevents squeeze film or viscous damping of the MEMS device.

11. A MEMS apparatus comprising:
a MEMS device;
an enclosure that encloses the MEMS device;
an enclosure having one or more vertical sidewalls,
an optical element located an opening in at least one of the sidewalls,
wherein at least one of the one or more sidewalls or the optical element includes a surface that is angled with respect to an optical plane.

12. The apparatus of claim 11, wherein the optical element is a window and at least one of the one or more sidewalls includes a surface that is angled with respect to an optical plane,
wherein the window is attached to the surface.

13. The MEMS apparatus of claim 11, wherein the MEMS device includes a substrate and the enclosure is bonded to the substrate.

14. The MEMS device of claim 13, further comprising a device controller chip attached to a back side of the substrate.

15. The MEMS apparatus of claim 11, wherein the MEMS device includes a substrate attached to a mount and the enclosure is bonded to the mount.

16. The MEMS apparatus of claim 11, wherein the enclosure is evacuated.

17. A MEMS module, comprising
a mount;
a MEMS device attached to the mount;
one or more optical fibers attached to the mount proximate the MEMS device; and
an enclosure attached to the mount and enclosing the MEMS device,
wherein the enclosure has one or more vertical sidewalls,
wherein at least one sidewall includes one or more optical elements sealed to an opening in the sidewall,
wherein the fibers are optically coupled to the device via the one or more optical elements,
wherein at least one of the one or more sidewalls or the optical element includes a surface that is angled with respect to an optical plane, and
wherein the fibers are located outside the enclosure.

18. The MEMS module of claim 17 wherein said optical element is a window and optical signals may be coupled between the MEMS device and the optical fibers through the one or more optical elements.

19. The MEMS module of claim 17 further comprising a control electronics unit coupled to the MEMS device.

20. The MEMS module of claim 19, wherein the control electronics unit is a device controller chip attached to a back side of a substrate of the MEMS device.

21. The MEMS module of claim 20, wherein the enclosure is evacuated.

22. The MEMS module of claim 20, wherein the enclosure is filled with a gas.

23. A method for switching optical signals with a microelectromechanical system (MEMS) optical device having one or more moveable MEMS optical elements, the steps comprising:
In a reduced pressure atmosphere proximate the MEMS optical device, moving at least one of the optical elements from a first position to a second position; and
deflecting an optical signal with the at least one optical element when it is in the second position.

24. The method of claim 23 further comprising:
returning the MEMS optical element to the first position.
